(19) United States
(12) Patent Application Publication
(10) Pub. No.: US 2025/0337778 A1
(43) Pub. Date: Oct. 30, 2025

(54) SYSTEMS AND METHODS FOR DETECTING PHISHING CAMPAIGNS

(71) Applicant: Royal Bank of Canada, Toronto (CA)

(72) Inventors: Nariman Mammadli, Toronto (CA); Saira Rizvi, Toronto (CA); Prakash Thiyagarajan, Toronto (CA); Tom Wisniewski, Toronto (CA); Felix Kurmish, Nepean (CA)

(21) Appl. No.: 19/186,179

(22) Filed: Apr. 22, 2025

Related U.S. Application Data
(60) Provisional application No. 63/638,561, filed on Apr. 25, 2024.

(51) Int. Cl. H04L 9/40

(52) U.S. Cl. CPC H04L 63/1483

(57) ABSTRACT

Methods, systems, and techniques for detecting phishing campaigns are disclosed, comprising: determining a pattern in a dataset of inbound emails, the pattern comprising a constant component and a variable component; determining a cluster of emails that share the pattern among the inbound emails; determining a number of unique features for a plurality of data fields among the cluster of emails; and determining whether the cluster of emails belong to a phishing campaign based on an evaluation of the number of unique features.

### CROSS-REFERENCE TO RELATED APPLICATIONS

This application claims the benefit of U.S. Provisional Patent Application No. 63/638,561, filed on Apr. 25, 2024, the entire contents of which is incorporated herein by reference for all purposes.

### TECHNICAL FIELD

The present disclosure is directed at methods, systems, and techniques for detecting phishing emails, and in particular to detecting phishing campaigns.

### BACKGROUND

Phishing attacks occur in a large volume and there are a variety of methods attackers employ to carry out a successful attack. Existing solutions for detecting phishing attempts operate on a per email basis, meaning that they judge each email separately to decide whether a given email is a phishing email or not. The majority of these existing solutions attempt to detect phishing attacks by analyzing the content of the email, which typically involves antivirus scanning of attachments, domain reputation analysis, URL analysis, etc.

However, existing solutions will at times miss some phishing emails, as evidenced by the high volume of phishing emails that still end up in user inboxes. Whenever there is a novel attack, existing solutions often fail to identify such emails because these systems rely heavily on past knowledge of phishing attacks for detection and already known malware or phishing domains. Moreover, attackers knowing that existing solutions judge each email separately may add variation across files, filenames, and even sender addresses (i.e. pretending multiple identities) in attempt to bypass phishing controls.

Accordingly, methods, systems, and techniques for detecting phishing emails remain desirable.

### SUMMARY

According to a first aspect, there is provided a method of detecting phishing campaigns, comprising: determining a pattern in a dataset of inbound emails, the pattern comprising a constant component and a variable component; determining a cluster of emails that share the pattern among the inbound emails; determining a number of unique features for a plurality of data fields among the cluster of emails; and determining whether the cluster of emails belong to a phishing campaign based on an evaluation of the number of unique features.

In some aspects, the pattern is determined in the dataset that is one of: attachment names, subject lines, and URLs of the inbound emails.

In some aspects, the plurality of data fields for which the number of unique features is determined comprise two or more of: sender address, recipient address, attachment names, subject lines, URLs, and email times, and includes a data field corresponding to the dataset comprising the pattern.

In some aspects, the evaluation of the number of unique features comprises evaluating a similarity between the number of unique features for each of the plurality of data fields.

In some aspects, the similarity is evaluated by computing a harmonic mean of the number of unique features for each of the plurality of data fields.

In some aspects, the method further comprises determining that the cluster of emails is a valid cluster when a number of emails in the cluster exceeds a threshold number.

In some aspects, the method further comprises preprocessing the dataset by replacing numbers with a generic number tag and/or by replacing names with a generic name tag.

In some aspects, determining the pattern in the dataset of inbound emails comprises tokenizing the data in the dataset, and determining the pattern based on tokens of the tokenized data.

In some aspects, determining the pattern comprises determining the constant component as a largest common string of the tokens.

In some aspects, determining the pattern in the dataset of inbound emails comprises, for each inbound email: generating nodes for each token; scoring the nodes according to the number of unique inbound emails that each respective node is present in; and determining the pattern in the dataset based on a largest node having a score above a threshold value.

In some aspects, generating the nodes for each token comprises building a trie tree structure.

In some aspects, the inbound emails are received over a preceding predetermined amount of time.

In some aspects, the method further comprises determining whether the cluster of emails belong to the phishing campaign based on an email frequency and/or email seasonality of the emails in the cluster of emails.

In some aspects, the method further comprises performing one or more of flagging, blocking, and quarantining the emails in the cluster of emails when it is determined that the cluster of emails belongs to the phishing campaign.

In some aspects, the method further comprises, when it is determined that the cluster of emails belongs to the phishing campaign, analyzing subsequent inbound emails for the pattern in the dataset, and performing one or more of flagging, blocking, and quarantining the subsequent inbound emails having the pattern in the dataset.

According to another aspect, there is provided a system for detecting phishing campaigns, comprising: a processor; and a non-transitory computer-readable medium having computer-executable instructions stored thereon which, when executed by the processor, configure the system to perform the method of any one of the above aspects.

According to another aspect, there is provided a non-transitory computer-readable medium having computer-executable instructions stored thereon which, when executed by a processor, configure the processor to perform the method of any one of any one of the above aspects.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a computer network that comprises an example embodiment of a system for detecting phishing campaigns.

FIG. 2 is a block diagram of a server comprising part of the system depicted in FIG. 1.

FIG. 3 depicts a method of detecting phishing campaigns in accordance with embodiments of the present disclosure.

FIG. 4 depicts an example method of determining a pattern in a dataset of inbound emails.

FIG. 5 depicts an example method of determining a pattern in a dataset of inbound emails using a trie tree algorithm.

FIGS. 6A-F depict an example embodiment of using a trie tree algorithm to determine a pattern in a dataset of inbound emails.

### DETAILED DESCRIPTION

The present disclosure provides methods, systems, and techniques for detecting phishing emails, and in particular detecting phishing campaigns. While existing phishing solutions judge emails individually to evaluate emails as benign emails or phishing emails, the present disclosure is directed to judging a cluster of emails sharing a same pattern to evaluate the cluster of emails as benign or as belonging to a phishing campaign. Accordingly, emails in a cluster that are determined to belong to a phishing campaign can be identified as phishing emails and appropriate action can be taken for all emails in the cluster, as well as for subsequent emails that are received and that share the same pattern as the emails in the cluster. Judging a cluster of emails as opposed to individual emails can improve detection accuracy and provide better defence against phishing attacks, and may also for example supplement existing phishing controls, which at times miss an entire phishing campaign or only catch certain emails belonging to the phishing campaign and not others. Moreover, analyzing a cluster of emails provides better visibility into the phishing styles that attackers use, such as varying certain data amongst a cluster of emails in attempt to bypass single-email phishing controls.

The methods, systems, and techniques for detecting phishing campaigns in accordance with the present disclosure judge a cluster of emails by analyzing datasets of data types/fields associated with the cluster of emails as opposed to content analysis. Analyzing datasets allows for modelling a behavioral aspect of threat actors, which is largely ignored by existing phishing controls. Thus, while existing phishing detection technologies mainly focus on sender domain/reputation analysis, natural language processing of the content of the email body, and sandbox analysis of the attached files to search for malware, the present disclosure of methods, systems, and techniques for detecting phishing campaigns does not rely upon any of these, but instead focuses on dataset analysis of inbound emails. The datasets of inbound emails that are analyzed may for example include sender address, recipient address, attachment names, subject lines, URLs (uniform resource locators), email times, etc.

In at least some embodiments herein, methods, systems, and techniques for detecting phishing campaigns comprise determining a pattern in a dataset of inbound emails, the pattern comprising a constant component and a variable component; determining a cluster of emails that share the pattern among the inbound emails; determining a number of unique features for a plurality of data fields among the cluster of emails; and determining whether the cluster of emails belong to a phishing campaign based on an evaluation of the number of unique features. In some embodiments, the pattern may be determined in one of the following datasets: attachment names, subject lines, and URLs, and the plurality of data fields for which the number of unique features is determined may comprise two or more of: sender address, recipient address, attachment names, subject lines, URLs, and email times, and includes a data field corresponding to the dataset comprising the pattern.

Accordingly, unlike existing phishing controls that analyze each email separately, the present disclosure of methods, systems, and techniques for detecting phishing campaigns determines a pattern in a dataset of inbound emails, identifies a cluster of emails that share the pattern, and evaluates a plurality of data fields for the cluster of emails to determine whether the cluster of emails belong to a phishing campaign. The methods, systems, and techniques for detecting phishing campaigns in accordance with the present disclosure are premised on the fact that attackers tend to add artificial variations to their emails in attempt to hide the fact that they belong together in a single campaign and bypass existing phishing controls. Accordingly, emails belonging to a phishing campaign tend to have machine-added variation while also containing a certain degree of symmetry. In accordance with the present disclosure, such artificial variations are detected by determining a pattern comprising a constant component and a variable component in a dataset of inbound emails, and therefore emails that share the pattern can be clustered together for analysis.

As one non-limiting example, a phishing campaign may for example send emails from different sender email addresses (to avoid being blacklisted), to different recipient addresses (e.g. different emails within an organization), and with unique subject lines. However, attachment names may share a predictable pattern, comprising a constant component and a variable component. For example, the attachment name of one email may be attachment_ab, the attachment name for another email may be attachement_cd, the attachment name for another email may be attachment_ef, etc. Accordingly, while the emails may be seemingly unrelated based on their uniqueness, a pattern of the attachment names, i.e. “attachment_xx”, can be determined and used to cluster the emails. A s attackers generally rely upon automation or shortcuts to introduce artificial variation amongst emails, it has been found that emails belonging to a phishing campaigns tend to have a pattern in at least one dataset that can be determined and utilized for detecting the phishing campaign.

Once the pattern and the email cluster have been determined, a number of unique features for a plurality of data fields among the cluster of emails is determined. For example, for a pattern that is observed in subject lines among a cluster of emails, a number of unique subject lines observed in the cluster is determined, as well as a number of unique features in one or more other data fields, such as sender and/or recipient addresses. The number of unique features is evaluated, such as by calculating an anomaly score, to evaluate the closeness of the number of features computed. It has been found that a phishing campaign can be identified as a suspicious cluster of emails that will have variation added across data fields of the email making the number of unique instances for all fields in consideration close to the total number of emails.

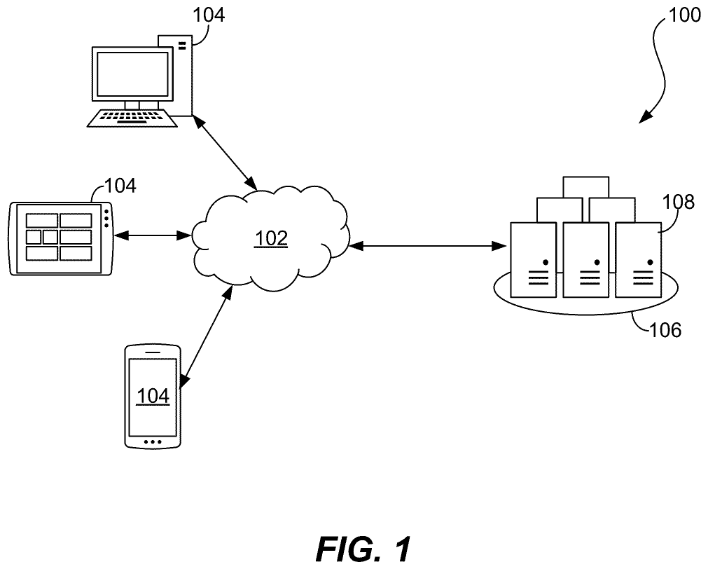

Referring now to FIG. 1, there is shown a computer network 100 that comprises an example embodiment of a system for detecting phishing campaigns. More particularly, the computer network 100 comprises a wide area network 102 such as the Internet to which various user devices 104, and data center 106 are communicatively coupled. The data center 106 comprises a number of servers 108 networked together to collectively perform various computing functions. For example, in an organization, the data center 106 may host online services provided by that organization, and may store sensitive information, such as confidential information belonging to the organization, customer/employee data, etc. In the context of a financial institution such as a bank, for example, the data center hosts online banking services that permit users to perform various computer-implemented banking services, and also stores sensitive customer information.

Employees of organizations are often the target of phishing attacks where attackers send phishing emails to employee emails that contain malicious software, URLs, etc. When a recipient clicks on a malicious URL or opens malicious software, the attackers can gain access to that employee's device and attempt to access sensitive information belonging to the organization. Accordingly, the risk of failing to detect a phishing email is very high, and it is desirable to get as close as possible to detecting phishing emails 100% of the time. While phishing controls may be provided at each of the employee devices (i.e. user devices 104) to attempt to identify individual phishing emails and quarantine/block such emails, in accordance with the present disclosure methods, systems, and techniques for detecting phishing campaigns is performed by analyzing emails received by different recipients, i.e. across user devices 104, by the one or more servers 108. Accordingly, the methods, systems, and techniques for detecting phishing campaigns in accordance with the present disclosure apply a holistic analysis to inbound emails and can provide an additional and/or alternative means of detecting phishing attempts and therefore improves cybersecurity. Improved cybersecurity means better defense against threats to an organization, as well as improved client/customer confidence.

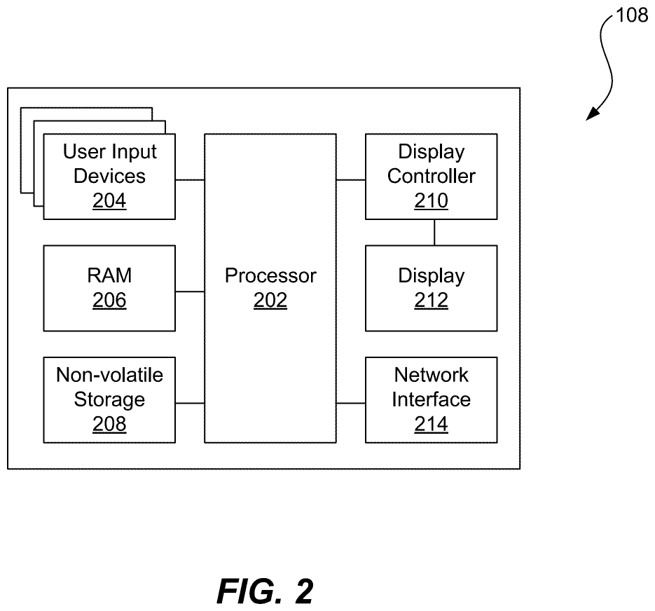

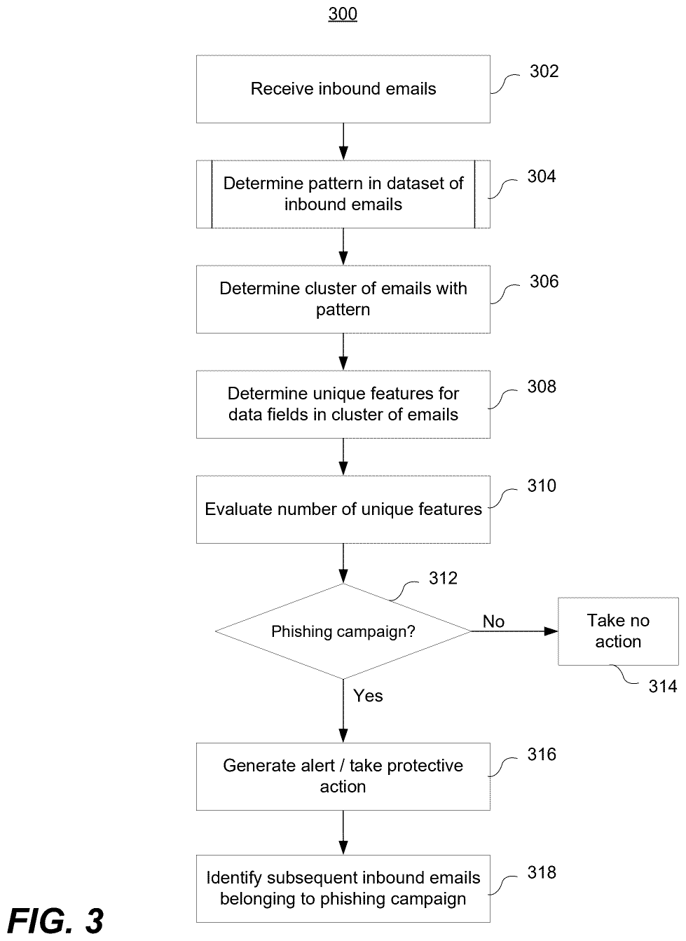

Referring now to FIG. 2, there is depicted an example embodiment of one of the servers 108 that comprises the data center 106. The server comprises a processor 202 that controls the server's 108 overall operation. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 104 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for detecting phishing campaigns, such as is described in more detail in respect of FIG. 3 below. Additionally or alternatively, the servers 108 may collectively perform that method using distributed computing. While the system depicted in FIG. 2 is described specifically in respect of one of the servers 108, analogous versions of the system may also be used for the user devices 104.

FIG. 3 depicts a method 300 of detecting phishing campaigns in accordance with embodiments of the present disclosure. The method 300 may be implemented at the one or more servers 108 of the data center 106 of an organization, for example. The method may be stored as computer program code, or non-transitory computer-readable instructions, which, when executed by the processor of the server, configure the server to implement the method 300.

The method 300 for detecting phishing campaigns is premised on the fact that phishing campaigns typically contain certain distinguishing characteristics. In particular, phishing campaigns typically have the following characteristics: (1) they randomly target employees within an organization (i.e. recipient email addresses are all different); (2) threat actors assume different identities to avoid being blacklisted (i.e. sender email addresses are all different), and (3) there is at least one field of data that is varied according to a predictable pattern.

Based on the above distinguishing characteristics, it is clear that threat actors are using email automation platforms to send out mass emails and are trying to add variations in small amount to each email to avoid detection from naïve phishing detection methods. The method 300 seeks to identify these variations among a cluster of emails to detect phishing campaigns. The variation that attackers add to emails may be random or a result of customizing the email for recipient. However, there is generally a pattern in at least one field of data among emails that comprises a constant component and a variable component, and which can be identified in a dataset of that data field.

The method 300 comprises receiving inbound emails to be analyzed (302). Receiving the inbound emails may comprise retrieving or otherwise obtaining the emails from a data storage. The inbound emails may comprise all emails that have been received by user devices within an organization over a preceding predetermined amount of time, e.g. in the last 12 hours, in a given day, week, month, etc. The inbound emails may comprise emails that have been filtered by existing phishing controls, if present on user devices, and may include both emails found benign and emails found to be phishing emails from the existing phishing controls. Logs from existing phishing controls may also be received, as well as employee data associated with the inbound emails.

The inbound emails to be analyzed may be pre-processed to remove emails that should not be analyzed. For example, the following emails may not be analyzed: outbound emails; emails without attachments and/or URLs (e.g. depending on a target dataset for determining the pattern); emails with invalid email addresses (e.g. email addresses containing =, &, %, +, ˜, $, #, or | may be considered invalid addresses), emails with missing data (e.g. missing any of the data fields such as recipient address, sender address, etc.); emails sent from within the organization; emails sent from whitelisted email addresses; emails with a high similarity between URL domain and sender domain (to remove email sender domain); emails with many URLs (e.g. greater than or equal to 5 URLs), which may correspond to marketing emails; and/or emails that have the same sender and recipients (e.g. emails from an individual's work email to personal email, or vice versa).

For example, emails that have the same recipient and sender may be identified by measuring the J aro-Winkler similarity score between the sender and recipient email addresses and if the score is greater than a threshold, e.g. 0.7, the two email addresses are considered to belong to the same individual. The Jaro-Winkler similarity measures the distance between the two strings by considering the similar characters in the two string and the number changes required to convert one string to the other. The J aro-Winkler similarity formula is as follows:

$${sim}_{j} = \{ \begin{matrix}0 & if m = 0 \\ \frac{1}{3} ( \frac{m}{\vert {s}_{1} \vert} + \frac{m}{\vert {s}_{2} \vert} + \frac{m - t}{\vert m \vert} ) & otherwise\end{matrix}$$

where: |s₁| is the length of the string s₁; m is the number of matching characters; t if the number of transpositions.

The method 300 comprises determining a pattern in a dataset of inbound emails (304). As described above, the method 300 is used to detect phishing campaigns that have a particular variation amongst emails, and such variation is identified by determining a pattern that comprises a constant component (also referred to as an “anchor” or “common component”) and a variable component in a dataset for a particular field of data. Attackers usually use either numerals (e.g. invoice_12.pdf, invoice_34.pdf, etc.), characters (e.g. invoice_ab.pdf, invoice_cd.pdf, etc.), or the names of the recipients to introduce variation in a data field. For example, one email may have an attachment titled “DocumentFolder_18948.pdf”, while another email has an attachment titled “DocumentFolder_8732.pdf”. In this example “DocumentFolder” would be a constant component, and the numbers following the constant component would be the variable component.

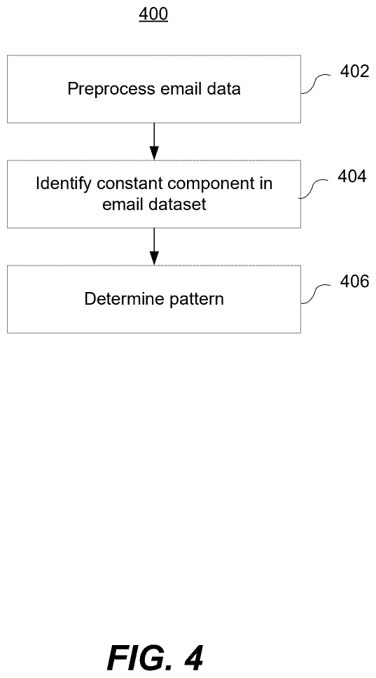

Emails comprise various data fields and generally include at least the following data fields: sender address, recipient address, subject line, and email times. Emails comprising attachments will also include data corresponding to the attachment name. Emails containing URLs will also include data corresponding to the URL. In accordance with the present disclosure, a pattern may in particular be determined in a dataset of attachment names, subject lines, and/or URLs. Different techniques may be used to identify patterns in different datasets. Example methods of determining a pattern in attachment names, subject lines, and URLs are described in more detail herein below with reference to FIGS. 4-6F. It will also be appreciated that while particular examples are provided for determining patterns in attachment names, subject lines, and URLs, patterns may also be found in other datasets for detecting phishing campaigns . . .

Inbound emails that share the pattern identified at 304 are identified and clustered (306). Specifically, emails sharing the pattern will have the same constant component in data corresponding to the data field, but a different variable component. Emails having the same constant component can be identified and grouped/clustered. A cluster may be considered valid when a threshold number of emails are present in the cluster (e.g. 10 or more emails). For example, if only two emails share the pattern, these two emails may not be considered a valid cluster for performing subsequent analysis.

A number of unique features of data for a plurality of data fields among the cluster of emails is determined (308) for use in scoring the cluster. The data fields of interest may include two or more of: sender address, recipient address, attachment names, subject lines, URLs, and email times. It will be appreciated that other data fields of interest may also be evaluated. The plurality of data fields for which the number of unique features is determined includes the data field comprising the pattern. For example, if a pattern is identified in attachment names, a number of unique features among the cluster of emails is determined for attachment names and at least one other data field (e.g. sender addresses), preferably two or more other data fields (e.g. sender addresses and recipient addresses, and/or additional other data fields), which increases the confidence of the subsequent evaluation result. For each of these data fields, a number of unique features in the data is determined among the cluster of emails. For example, for a cluster of emails, a number of unique sender addresses, a number of unique recipient addresses, and a number of unique attachment names, may be determined. For a pattern identified in subject lines, a number of unique emails, number of unique subject lines, number of unique senders, and number of unique receivers may be determined. As another example, for a pattern identified in URLs, the number of unique features may be calculated for the following data fields: number of unique recipients, number of unique senders, number of unique emails, number of unique subject lines, and number of unique URLs. The method comprises determining a number of unique features for each such data fields because another common characteristic of phishing attacks is that for an attacker that is targeting N number of recipients, it is very likely that the number of unique senders and recipients used in a campaign will closely match if not equal to N, and that the number of unique data in the dataset having the pattern (e.g. the number of unique attachment names) will be very close to N as well.

The number of unique features determined at 308 is evaluated for use in determining whether the cluster of emails belong to the phishing campaign (310). Evaluating the number of unique features may comprise evaluating a similarity between the number of unique features for each data field. As described above, the closer the number of unique features for the plurality of data fields are to one another, the more likely the cluster of emails are to be part of a phishing campaign. Evaluating the number of unique features may comprise calculating an anomaly score. In some aspects, the anomaly score may be calculated as the harmonic mean of the number of unique features for each of the plurality of data fields.

For example, if there were 32 emails on a given day using the common attachment name pattern “documentfolder”, if these emails were all part of a phishing campaign it would be expected to see 32 unique emails, 32 unique attachment names, 32 unique sender addresses, and 32 unique receiver addresses. So, the anomaly score may be computed as the harmonic mean of the features divided by the sum of all the features, as shown below.

$$\frac{Harmonic Mean}{Total} = \frac{1}{{\sum }_{i}^{n} {x}_{i}} ( \frac{n}{{\sum }_{i}^{n} {x}_{i}^{- 1}} )$$

When the value of the features, xi, (i.e. the number of unique features of data in a respective data fields i) is close to each other the anomaly score is going to be close to 1/n, where n is the number of features or data fields being evaluated. A threshold value of 0.245, for example, may be selected in this case since it is close to ¼. Any email cluster evaluated on these four data fields that has an anomaly score greater than the threshold may be considered anomalous. It will be appreciated that if a different number of data fields are evaluated, the threshold score may be changed. For example, if there are five data fields being evaluated, the threshold may be selected as 0.17. It will also be appreciated that different threshold values may be set to limit false positives or to provide more conservative detection.

In addition to evaluating the number of unique features determined for a plurality of data fields among the cluster of emails (i.e. by calculating an anomaly score as described above), other metrics may also be calculated/considered for determining whether the cluster of emails belong to a phishing campaign to further improve detection. For example, for evaluating clusters that have a pattern in email subject lines, it has been found that to make subject lines less suspicious threat actors might try to choose subject lines that are very common and to variation in a very predictable manner, and these clusters end up having a constant amount of added variation. Therefore, if there is a cluster of emails where the number of tokens in the subject lines cover a large range, the cluster is less likely to be machine generated and may be considered benign. As a result, in addition to considering a cluster to be benign when an anomaly score is less than a threshold value (e.g. less than 0.24), another metric may be considered for clusters based on subject line where the cluster is considered benign if the standard deviation of number of tokens that are different from the constant component of the pattern is greater than 0.25, for example. As another example, for a pattern that has been detected in URLs, other scores may be calculated to enhance the performance of the model, such as: computing the standard deviation of the number of URLs in each email of the cluster (typically, a true phishing campaign is likely to have the same number of URLs, especially if it was generated using a template for mass reach, while adding different numbers of URLs will require more work on the part of the threat actor); calculating a number of days a cluster is seen in the last 30 days (e.g. if the cluster is very common then it is more likely to be benign as threat actors are more likely to change their social engineering tactics); retrieving a mean URL web score assigned by existing phishing controls, etc.

Further, additional filters for determining whether the cluster of emails belong to a phishing campaign can be considered. One example of an additional filter may comprise evaluating a temporal aspect of the emails in the cluster such as an email frequency and/or email seasonality of the emails in the cluster of emails, where emails belonging to a phishing campaign will generally follow a temporal pattern. Another example of an additional filter is that for patterns identified in URLs, an additional filter for determining whether the cluster of emails belong to a phishing campaign may comprise determining a reputation score of the domain, determining whether emails have been previously received with URLs having the same domain, etc. It will be appreciated that various additional filters can be applied, which may help to limit the number of false positives in the detection results.

After determining whether a cluster of emails belong to a phishing campaign, appropriate actions may be taken. For example, referring again to the method 300 shown in FIG. 3, a determination may be made as to whether the cluster of emails belongs to a phishing campaign (312), and if not (NO at 312), no action is required (314), and the results may be stored appropriately. Alternatively, if the cluster of emails belongs to a phishing campaign (Y ES at 312), an alert may be generated and protective action may be taken (316), such as alerting users and/or cybersecurity teams, quarantining and/or blocking the emails, etc. Alerts may take various forms and comprise various relevant output data, such as the recipient's email address, the sender's email address, the email subject line, original attachment names, suspicious file(s), suspicious URL(s), email timestamp, an indication of whether the email was delivered or blocked, etc. Further, subsequent inbound emails may be analyzed in real-time for data matching the pattern, and such emails may be identified in real-time as belonging to the phishing campaign and appropriate action taken (318).

In some embodiments, for a given period of time, a top N clusters of suspected phishing campaigns may be acted on/reported, where the top N clusters are selected based on the anomaly scores and optionally other scores/metrics as well. For example, each day, the system may select a top 3 suspicious clusters by filtering out benign clusters and selecting the top 3 suspicious clusters with the highest anomaly scores. For attachment names, for example, candidate clusters may be selected by removing clusters with anomaly scores less than 0.24 and z-score of number of days processed attachment is seen greater than 0. For subject lines, it has been observed that using a number of days seen for subject lines to remove benign clusters filtered out a lot of phishing clusters, possibly because threat actors might be trying to choose subject lines that are very common. However, to make the subject lines less suspicious, threat actors typically add variation in a predictable manner and these clusters end up having a constant amount of added variation. Therefore, a cluster where the number of tokens in the subject lines cover a large range, the cluster is less likely to be machine generated. As a result, candidate clusters may be removed with anomaly scores less than 0.24 and standard deviation of number of tokens that are different from the constant component or “anchor” of greater than 0.25. For URLs, suspicious clusters may be selected based on the following criteria: standard deviation of number of URLs is <=1 (this assumes a phishing campaign has a similar number of URLs across all emails of the campaign); z-score for number of days seen for a cluster is <=0 (a rare cluster is more suspicious); mean URL web score is rated as suspicious by an existing phishing control (i.e. does not have a high reputation score); and the anomaly score is greater than or equal to 0.17 (based on an evaluation of unique features across five data fields).

As described above, the method 300 requires determining a pattern in a dataset of inbound emails at 304. Determining the pattern requires analyzing the dataset to find a common component that can be used to group/cluster emails together. There may be many ways for determining a pattern in a dataset. Two example methods are described below.

FIG. 4 depicts an example method 400 of determining a pattern in a dataset of inbound emails. The method 400 may for example be performed to determine a pattern in attachment names, however a similar method can be applied for determining a pattern in other datasets, as described further below. The method 400 comprises preprocessing the dataset (e.g. preprocessing the attachment names) for a collection of inbound emails to be analyzed (402). Preprocessing may comprise removing any numbers in the attachment name and replacing it with a generic number tag, e.g. “#”. Preprocessing may also comprise extracting any recipient names based on the recipient email address and replacing that in the attachment names with a generic name tag, e.g. “(name)”. Preprocessing may also for example comprise making all text lowercase, removing file extensions, etc. Accordingly, an attachment name “DocumentFolder_0001.pdf” may be replaced with “documentfolder_#” after preprocessing, and an attachment name “Bank Statement April 2023 saira Rizvi.pdf” may be replaced with “bank statement april #(name) (name)”. Based on these processed attachment names, a constant component in the attachment name dataset amongst different emails can be identified (404). For example, it may be found that several emails comprise a constant component “documentfolder” followed by a variable component “#”. A pattern is determined for a valid cluster (406) based on the number of emails having attachment names with the same constant component. The pattern may be determined when a threshold number of emails sharing the constant component are identified, e.g. more than 5, more than 10, etc.

Similarly, a pattern in subject lines can be determined by removing variation from the subject line dataset and identifying a common component. Subject lines are typically more likely to contain variation that includes a combination of numbers and letters, and therefore simply removing numbers and names from the subject line may not be sufficient to determine a pattern, and instead the constant component may be determined by finding the largest common string in the dataset that form a valid cluster, where a valid cluster is a group of emails sharing a common pattern and containing more than a threshold number of unique emails.

A similar concept can be applied for phishing emails containing URLs, where the constant component may for example be the domain part of the URL or even the whole URL. However, to determine the constant component and extract the “anchor” from URLs, a different procedure is applied. URLs are more likely to contain variation that includes a combination of numbers and letters, and therefore simply removing numbers and names and replacing them with generic tags in the URLs does not suffice. Instead, the algorithm looks for the longest common string in URLs that form a valid cluster, which is done by tokenizing the URL by parsing URL components, e.g. domain (without www.), URL path numbers and special characters, URL parameters, URL query, and URL fragment. Here, URL path numbers and special characters may be replaced by a generic number/character tag, e.g. “#”. An example of a URL tokenizing code is provided below.

```
from urllib.parse import urlparse
def parse_url(url):
  # url = re.sub(‘([0-9] | \\−)+’,’ url.lower( ))
  parsed = urlparse(url)
  parsed_url = [parsed.netloc.replace(www., “”), re.sub(‘([0-9] | \\−)+’, ‘#’,
parsed.path).replace(“/”, “”), parsed.params, parsed.query, parsed.fragment]
  parsed_url = [url_comp for url_comp in parsed_url if (url_comp!=“”)]
  return parsed_url
```

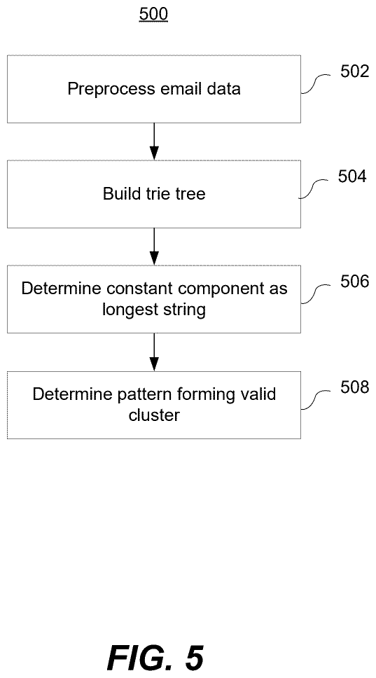

Finding a largest common string in a dataset may be performed by using a trie tree algorithm. FIG. 5 depicts an example method 500 of determining a pattern in a dataset of inbound emails using a trie tree algorithm. . . . The method 500 uses a trie tree algorithm that looks for the largest common string in the dataset that form a valid cluster, where a valid cluster is a group of emails sharing a common pattern and containing more than a threshold number of unique emails.

The method 500 comprises preprocessing the dataset (502), building a trie tree using the dataset (504), determining a constant component in the dataset by using the trie tree to find the longest common string (506), and determining a pattern for a valid cluster of emails sharing the constant component (508).

Preprocessing the dataset may involve similar processing as described with reference to the method 400. For example, subject line text may be made lowercase, numbers may be replaced with a number tag, e.g. “#”, and names may be replaced with a name tag, e.g. “(name)”. Further, the data in the dataset may be tokenized as part of the preprocessing. The definition of a token can vary based on the type of data string. For attachment names, a token can be the substrings that are separated by a space or a special character. For subject lines, a token can simply be a word. For URLs, the tokenization process may follow the process described above.

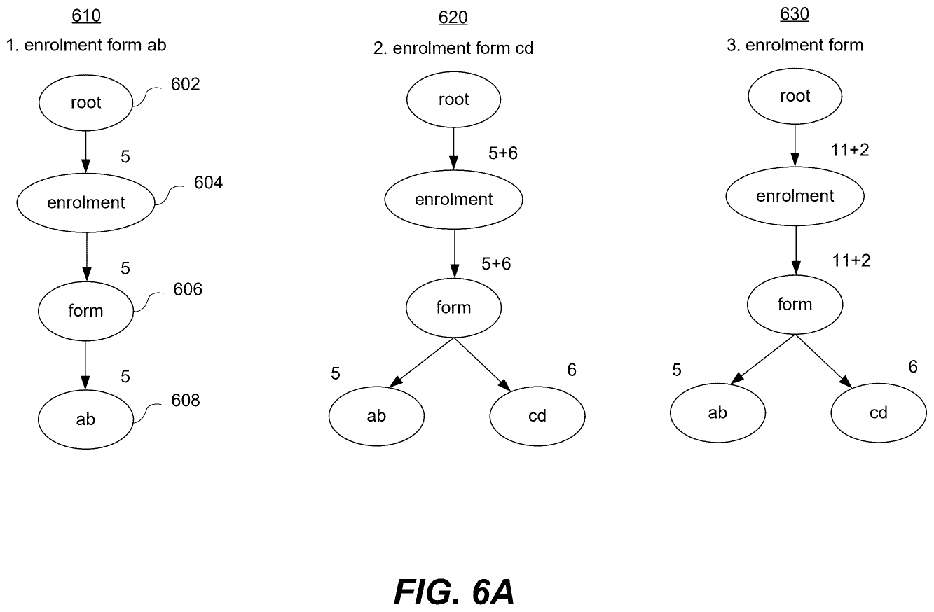

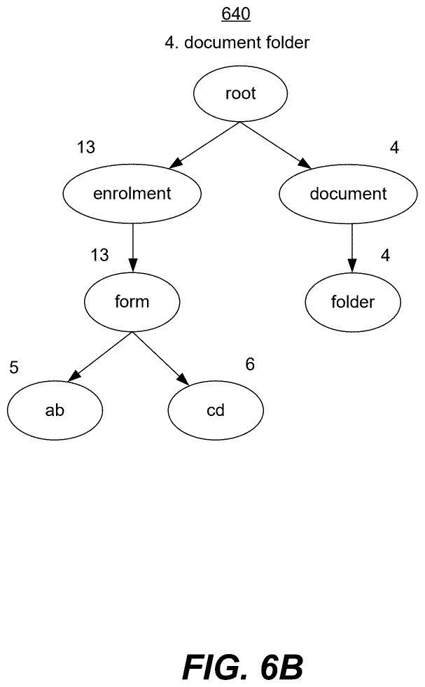

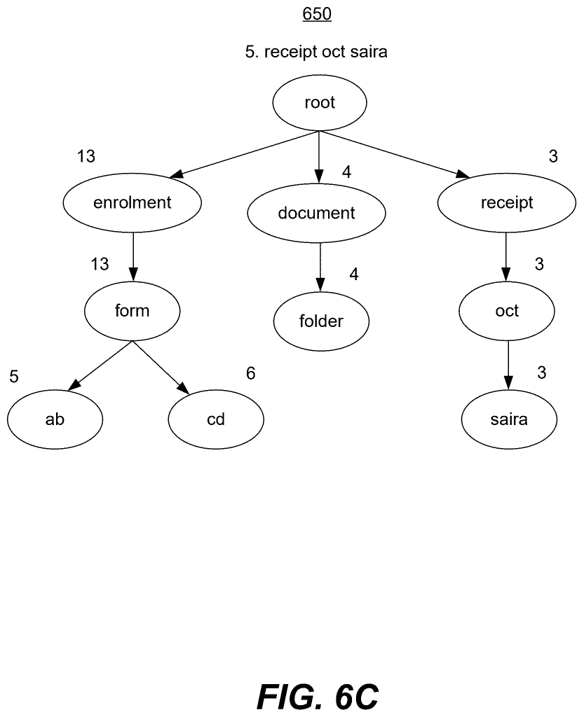

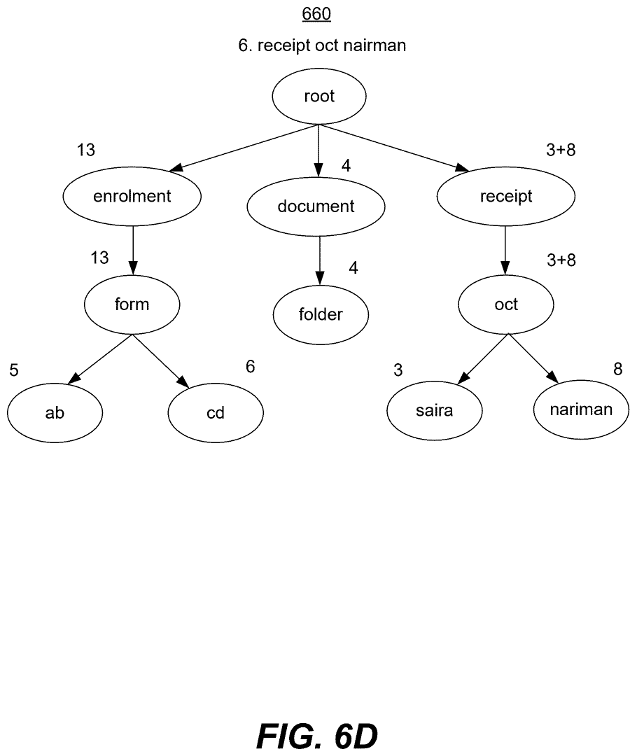

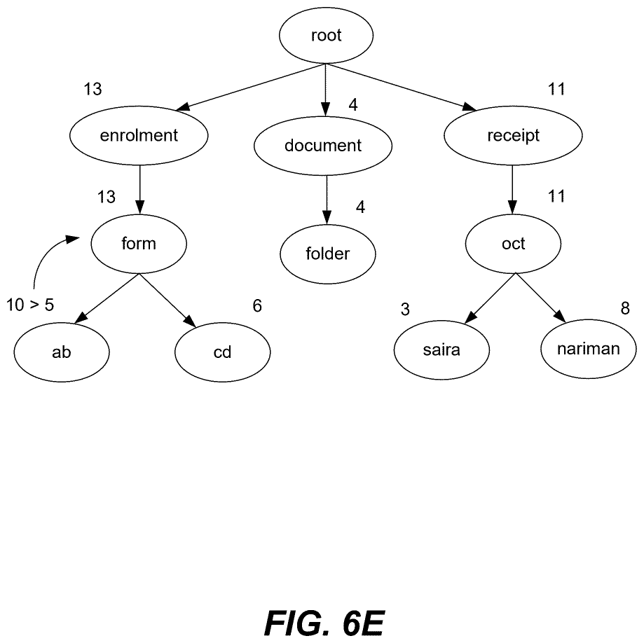

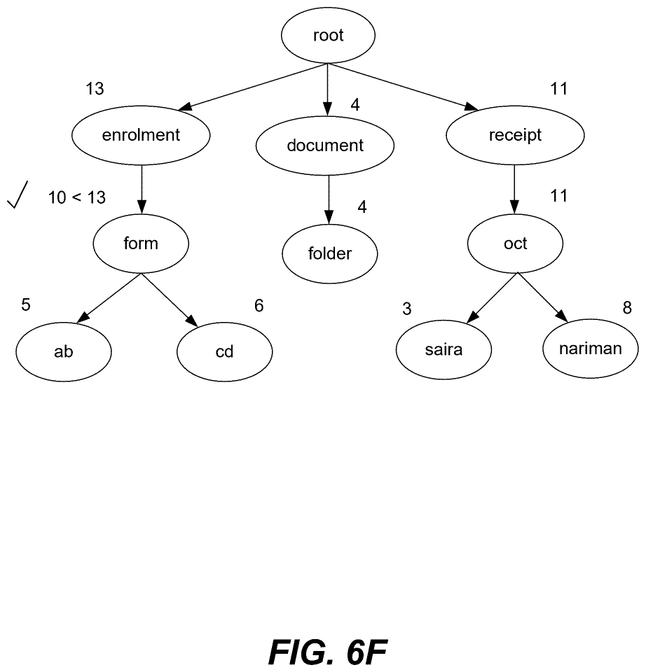

Building a trie tree and determining a constant component in the dataset using the trie tree are described further with reference to FIGS. 6A-F. FIGS. 6A-F depict an example embodiment of using a trie tree algorithm to determine a pattern in a dataset of inbound emails, which in this example considers a dataset of attachment names.

In FIGS. 6A-F, the following sample data was considered:

| Attachment Name | # of unique emails |
|---|---|
| receipt oct saira | 3 |
| receipt oct nariman | 8 |
| enrolment form cd | 6 |
| enrolment form ab | 5 |
| enrolment form | 2 |
| document folder | 4 |

With reference to FIGS. 6A-D, to build the trie tree, attachment names are inserted to the tree starting from the “root” node (e.g. denoted as node 602). Each token of the attachment names is represented by a separate node. For example, “enrolment” is shown denoted as node 604, “form” is denoted as node 606, and “ab” is denoted as node 608. If the node is not in the graph, a new node is created and the number of unique emails is the score for each new node. If the node is present, the number of unique emails is added to the current node. For example, the trie tree 610 shows a state of the trie tree after adding emails with attachment names “enrolment form ab”; trie tree 620 shows a state of the trie tree after adding emails with attachment names “enrolment form cd”; trie tree 630 shows a state of the trie tree after adding emails with the attachment name “enrolment form”; trie tree 640 shows a state of the trie tree after adding emails with the attachment name “document folder”; trie tree 650 shows a state of the trie tree after adding emails with the attachment name “receipt oct saira”; and trie tree 660 shows a state of the trie tree after adding emails with the attachment name “receipt oct nariman”. The number of unique emails containing each node in its dataset is represented by the number associated with each node in the trie tree.

Once the trie tree has been built, a number of unique emails for each string can be determined, which can be used to determine a longest string that is a constant component present in a valid cluster of emails. The score on each node represents the number of unique emails for that data string. If a valid cluster is considered to contain a threshold number of emails, e.g. at least 10 unique emails, for each string the trie tree can be evaluated starting from the lowest node and continue to move up until a node with a score greater than 10 is found. This represents the longest string that is a constant component for a valid cluster. For example, as represented in FIG. 6E, there are only 5 unique emails with the attachment comprising the string of tokens “enrolment form ab”, which is not enough to represent a valid cluster. Moving up the trie tree, as represented in FIG. 6F, there are 13 unique emails with the attachment comprising the tokens “enrolment form”, which satisfies a valid cluster. Accordingly, the pattern may be determined to have a constant component “enrolment form” followed by a variable component. Psuedo-code for determining nodes forming a valid cluster is provided below.

```
tokens = [token 1, token 2, ..., token n]
while tokens != [ ]:
  score = trie(tokens) #look up node in trie tree and retrieve score
  if score >10:
    return tokens
  else:
    tokens = tokens [0:−1]
return “_root_”
```

Another example implementation of the trie tree algorithm is now described. The implementation of the trie tree algorithm needs to be efficient given the large volume of inbound emails to be analyzed. In this example, the following approach was used considering a valid cluster size of 10: (1) tokenize filenames and generate node names; (2) generate final node scores; (3) filter to remove nodes with a score less than a valid cluster size (e.g. 10); and (4) retrieve the largest node in length.

Tokenizing the filenames and generating the node names for a sample dataset is shown in the Table below.

| Tokens | Node Names |
|---|---|
| [documents, for, #, canada, inc.] | [‘documents' |
| | ‘documents for’ |
| | ‘documents for #’ |
| | ‘documents for # canada’ |
| | ‘documents for # canada inc.’] |
| [documents, for, #, canada, inc., #, signature | [‘documents' |
| card] | |
| | ‘documents for’ |
| | ‘documents for #’ |
| | ‘documents for # canada’ |
| | ‘documents for # canada inc.’ |
| | ‘documents for # canada inc. #’ |
| | ‘documents for # canada inc. # signature’ |
| | ‘documents for # canada inc. # signature card’] |

To generate the score for each node that was generated in the table above, the column and node name are exploded, and a groupBy and sum is performed to provide a score for each node, as shown in the Tables below. In this example, there were 4 unique emails that had a pattern of [documents for #canada inc] and 8 unique emails that had a pattern of [documents for #canada inc #signature card]. Accordingly, a summation of the number of unique emails for the node with token ‘documents’ is 4+8=12, while a summation of the number of unique emails for the node with tokens ‘documents, for #canada inc #signature card’ is simply 8.

| Node Names | Number of Unique E mails/Score |
|---|---|
| ‘documents' | 12 |
| ‘documents for’ | 12 |
| ‘documents for #’ | 12 |
| ‘documents for # canada’ | 12 |
| ‘documents for # canada inc.’ | 12 |
| ‘documents for # canada inc. #’ | 8 |
| ‘documents for # canada inc. # signature’ | 8 |
| ‘documents for # canada inc. # signature card’ | 8 |

The DataFrame is filtered to remove nodes with a score less than the predefined valid cluster size of 10, so the nodes ‘documents for #canada inc. #’; ‘documents for #canada inc. #signature’; and ‘documents for #canada inc. #signature card’ are removed.

The largest remaining node (in length) is retrieved, i.e. “document for #canada inc”, which is considered as the constant component of the pattern among the group of emails forming a valid cluster.

The systems, methods, and techniques for detecting phishing campaigns disclosed herein have been tested and were effective at detecting known phishing campaigns. Moreover, the systems, methods, and techniques for detecting phishing campaigns disclosed herein were evaluated against a number of true positive phishing campaigns, a number of phishing emails that were delivered, and a number of phishing emails detected.

The following table shows results for phishing campaigns where a pattern was detected in attachment names. The number of phishing emails detected corresponds to the number of phishing emails that were detected using the methods and techniques disclosed herein. The number of phishing emails delivered corresponds to the number of phishing emails that bypassed existing phishing controls and were actually delivered to email inboxes, and thus were only detected using the methods and techniques disclosed herein.

| | # of true | # phishing | # of phishing |
|---|---|---|---|
| | positives | emails | emails |
| Month | campaigns | detected | delivered |
| November 2023 | 3+ | ~2811 | 2811 |
| December 2023 | 6 | ~200 | 70 |
| January 2024 | 6 | 145 | 94 |
| February 2024 | 7 | 457 | 5 |

The following table shows results for cases where a pattern was detected in subject lines.

| | # of true | # phishings | # of phishing |
|---|---|---|---|
| | positives | email | emails |
| Month | campaigns | detected | delivered |
| January 2024 | 2 | 369 | 218 |
| February 2024 | 4 | 151 | 151 |

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROM s and DV Ds, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (A SIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of detecting phishing campaigns, comprising:
determining a pattern in a dataset of inbound emails, the pattern comprising a constant component and a variable component;
determining a cluster of emails that share the pattern among the inbound emails;
determining a number of unique features for a plurality of data fields among the cluster of emails; and
determining whether the cluster of emails belong to a phishing campaign based on an evaluation of the number of unique features.

2. The method of claim 1, wherein the pattern is determined in the dataset that is one of: attachment names, subject lines, and URLs of the inbound emails.

3. The method of claim 1, wherein the plurality of data fields for which the number of unique features is determined comprise two or more of: sender address, recipient address, attachment names, subject lines, URLs, and email times, and includes a data field corresponding to the dataset comprising the pattern.

4. The method of claim 1, wherein the evaluation of the number of unique features comprises evaluating a similarity between the number of unique features for each of the plurality of data fields.

5. The method of claim 4, wherein the similarity is evaluated by computing a harmonic mean of the number of unique features for each of the plurality of data fields.

6. The method of claim 1, further comprising determining that the cluster of emails is a valid cluster when a number of emails in the cluster exceeds a threshold number.

7. The method of claim 1, further comprising preprocessing the dataset by replacing numbers with a generic number tag and/or by replacing names with a generic name tag.

8. The method of claim 1, wherein determining the pattern in the dataset of inbound emails comprises tokenizing the data in the dataset, and determining the pattern based on tokens of the tokenized data.

9. The method of claim 8, wherein determining the pattern comprises determining the constant component as a largest common string of the tokens.

10. The method of claim 8, wherein determining the pattern in the dataset of inbound emails comprises, for each inbound email:
generating nodes for each token;
scoring the nodes according to the number of unique inbound emails that each respective node is present in; and
determining the pattern in the dataset based on a largest node having a score above a threshold value.

11. The method of claim 10, wherein generating the nodes for each token comprises building a trie tree structure.

12. The method of claim 1, wherein the inbound emails are received over a preceding predetermined amount of time.

13. The method of claim 1, further comprising determining whether the cluster of emails belong to the phishing campaign based on an email frequency and/or email seasonality of the emails in the cluster of emails.

14. The method of claim 1, further comprising performing one or more of flagging, blocking, and quarantining the emails in the cluster of emails when it is determined that the cluster of emails belongs to the phishing campaign.

15. The method of claim 1, further comprising, when it is determined that the cluster of emails belongs to the phishing campaign, analyzing subsequent inbound emails for the pattern in the dataset, and performing one or more of flagging, blocking, and quarantining the subsequent inbound emails having the pattern in the dataset.

16. A system for detecting phishing campaigns, comprising:
a processor; and
a non-transitory computer-readable medium having computer-executable instructions stored thereon which, when executed by the processor, configure the system to perform a method comprising:
determining a pattern in a dataset of inbound emails, the pattern comprising a constant component and a variable component;
determining a cluster of emails that share the pattern among the inbound emails;
determining a number of unique features for a plurality of data fields among the cluster of emails; and
determining whether the cluster of emails belong to a phishing campaign based on an evaluation of the number of unique features.

17. A non-transitory computer-readable medium having computer-executable instructions stored thereon which, when executed by a processor, configure the processor to perform a method comprising:
determining a pattern in a dataset of inbound emails, the pattern comprising a constant component and a variable component;
determining a cluster of emails that share the pattern among the inbound emails;
determining a number of unique features for a plurality of data fields among the cluster of emails; and
determining whether the cluster of emails belong to a phishing campaign based on an evaluation of the number of unique features.
